(19) United States
(12) Patent Application Publication
(10) Pub. No.: US 2025/0304255 A1
(43) Pub. Date: Oct. 2, 2025

(54) SYSTEM FOR DISPLAYING ASTRONOMICAL OBJECTS AND EVENTS VIEWABLE BY PASSENGERS ALONG FLIGHT ROUTE

(71) Applicant: Thales Avionics, Inc., Irvine, CA (US)

(72) Inventor: Margaret STUART, Mission Viejo, CA (US)

(21) Appl. No.: 18/620,571

(22) Filed: Mar. 28, 2024

(51) Int. Cl. B64D 11/00

(52) U.S. Cl. CPC B64D 11/0015; B64D 2011/0061

(57) ABSTRACT

Various embodiments of the present disclosure are directed to an IFE system including at least one network interface, at least one processor connected to communicate through the at least one network interface, and at least one memory storing instructions executable by the at least one processor to perform operations. The operations include obtaining an aircraft geographic location and heading. The operations also include selecting a set of AOEs from an AOEs database that satisfy a relevance rule to what is viewable by a passenger through a window of an aircraft. The operations also include communicating with a display device to display an indication of the AOEs in the selected set which are viewable by the passenger.

### FIELD OF THE INVENTION

The described embodiments relate generally to display technologies of aircraft inflight entertainment systems for displaying information to aircraft passengers and crew.

### BACKGROUND

Inflight entertainment (IFE) systems are deployed onboard aircraft to provide entertainment services for passengers in a passenger cabin. The IFE systems typically distribute on-demand and/or streaming channels of movie, television, audio, electronic publications, and gaming entertainment programming to displays and audio interfaces of passenger-operated electronic communication devices. IFE systems also typically have a ground map displaying information related to a passenger's current flight including an illustration of flight paths and information related to the flight. The passenger-operated electronic communication devices can include, without limitation, seat video units that are mounted to individual seats, e.g., seatbacks or armrests, and/or passenger electronic devices (PEDs) transported onboard aircraft.

Passenger satisfaction with a flight experience and, ultimately, with an airline can be significantly impacted by the functionality of an IFE system and by what content is made available to passengers through the IFE system. There is a need to provide innovative passenger experiences through IFE system with dynamically changing content in a continuing effort to improve passenger flight satisfaction.

### SUMMARY

Various embodiments of the present disclosure are directed to an IFE system including at least one network interface, at least one processor connected to communicate through the at least one network interface, and at least one memory storing instructions executable by the at least one processor to perform operations. The operations include obtaining an aircraft geographic location and heading. The operations also include selecting a set of astronomical objects and events (AOEs) from an AOEs database that satisfies a relevance rule to what is viewable by a passenger through a window of an aircraft. The operations also include communicating with a display device to display an indication of the AOEs in the selected set which are viewable by the passenger.

Other IFE system apparatuses according to embodiments of the present disclosure will be or become apparent to one with skill in the art upon review of the following drawings and detailed description. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, which:

FIG. 1 illustrates a view of stars forming the Southern Cross constellation, one type of astronomical objects and events (AOEs), which is determined by an IFE system to be viewable in the nighttime sky of the Southern Hemisphere by passengers through windows along one side of an aircraft, in accordance with some embodiments of the present disclosure;

FIG. 2 illustrates information displayable by the IFE system through display devices to passengers who are located along the side of the aircraft in FIG. 1 to inform the passengers of the viewable AOEs, in accordance with some embodiments of the present disclosure;

FIG. 3 illustrates other information that is displayable through displays to passengers to inform the passengers of what AOEs are presently viewable through their respective windows and what AOEs will become viewable as the aircraft continues along its planned flight route, in accordance with some embodiments of the present disclosure;

FIG. 4 illustrates an interior view of an aircraft cabin with a current or future view of AOEs in the sky projected on the ceiling of the cabin in accordance with some embodiments of the present disclosure;

FIG. 5 illustrates a flight route displayed to a passenger through a display device that allows a passenger to move an aircraft icon along the flight route to various locations causing the IFE system to display updated listings of AOEs that will be viewable when the aircraft arrives at those locations in accordance with some embodiments of the present disclosure;

FIG. 6 illustrates a displayed view of a flight path that traverses the track of a total solar eclipse, and operates to allow a pilot to plan a modified flight route segment that will increase the duration of eclipse viewing opportunities for passengers in accordance with some embodiments of the present disclosure; and

FIG. 7 illustrates an example simplified system block diagram of a system that includes aircraft-based and ground-based system components that can be operated in accordance with some embodiments.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components, and circuits have not been described in detail so as not to obscure the present invention. It is intended that all embodiments disclosed herein can be implemented separately or combined in any way and/or combination.

Decades ago travel between faraway places by airlines was viewed with a sense of adventure and exploration, and ceremonial certificates were awarded to travelers who crossed the equator, the Pacific Ocean, etc. As non-stop air travel between continents became commonplace, such travel became viewed more negatively with an increasing focus on the lengthy travel time and lack of uniqueness of the travel experience.

While IFE systems have provided the opportunity for passengers to be entertained during such lengthy trips, the entertainment experience is relatively similar to what passengers can experience at home and hotels. For example, IFE systems have provided access to movies, television stations, audio programming, electronic publications, and gaming entertainment through seat video units and PEDs.

Aircraft have cabin windows which are rarely used, especially at night when passengers believe there is nothing to view. However, aircraft provide unique but rarely utilized opportunities for viewing astronomical objects and events (AOEs) because of aircraft high flight altitudes above most cloud formations and away from ground light pollution, and aircraft flight routes rapidly traversing vastly different viewing perspectives of the night sky.

Various embodiments of the present disclosure are directed to IFE system operations which encourage passengers to experience the AOEs that are presently viewable through the aircraft windows and to guide passengers as to what AOEs will become viewable along the planned flight route during their trip. The AOEs can include, without limitation, planets, stars, constellations, Moon, and transitory objects such as solar eclipses, lunar eclipses, space stations, satellites, and rocket launches (e.g., satellite launches, crew/supply launches to space stations, planetary/deep-space mission launches, etc.).

The IFE system can determine for individual passengers what AOEs are viewable or will become viewable based on a database of AOEs and their respective locations relative to Earth and through computation of the passenger's field-of-view (FOV) through the closest window to the passenger's seat based on where the aircraft is located, the flight route of the aircraft, aircraft heading, aircraft pitch and/or roll, present and forecasted aircraft ground speed, where the passenger is seated along the cabin (e.g., which side of cabin, distance of seat from window, etc.), etc. The IFE system may inform passengers when transitory objects such as solar eclipses, lunar eclipses, space stations, rocket launches, etc. will become viewable and the duration of viewability based on where the aircraft is located, the flight route of the aircraft, aircraft heading, aircraft pitch and/or roll, present and forecasted aircraft ground speed, the passenger's FOV through the closest window, etc.

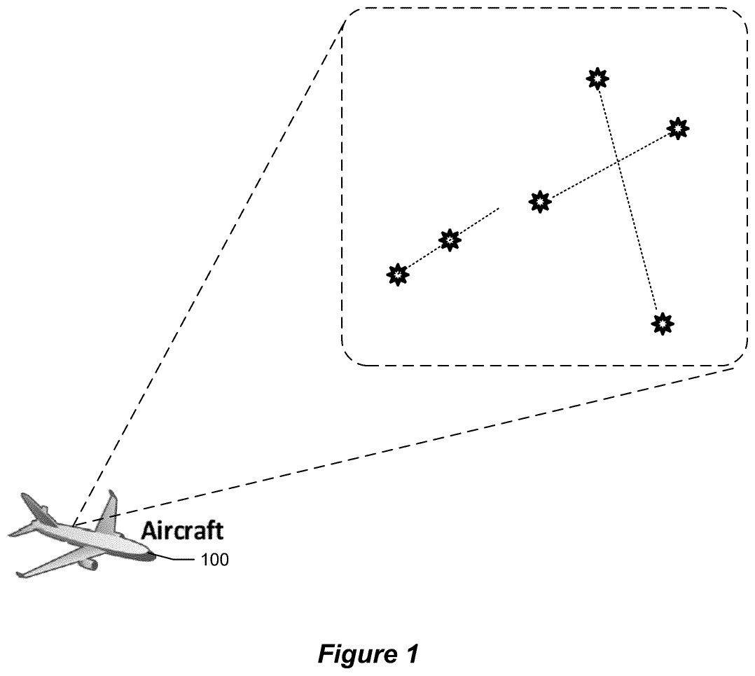

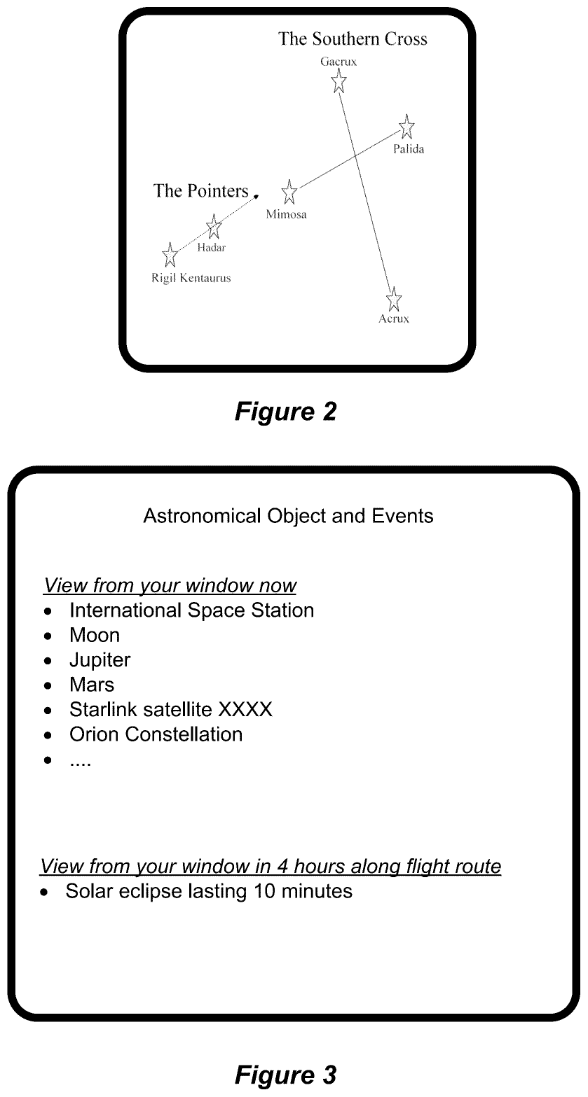

The IFE system may also highlight to passengers what AOEs are unique relative to what they can view in the sky at their home location. For example, Crux is a constellation commonly known as the Southern Cross (illustrated in FIGS. 1 and 2) which is viewable only in the southern hemisphere, and which the IFE system may highlight as a unique viewing experience for passengers flying from the northern hemisphere (or having home addresses in the northern hemisphere) to the southern hemisphere. The IFE system may also display information to passengers guiding where the passengers should look through their respective windows toward the sky to view certain AOEs, e.g., as shown by the graphical rendering displayed in FIG. 2 as will be discussed below.

Various embodiments are directed to IFE systems which are operative to display live views and future views of AOEs that are presently viewable or will become viewable in the sky, and various types of information regarding the AOEs and graphical objects representative of the AOEs, such as graphical animations, for viewing by passengers. The information and objects may be displayed on seat video display units, PEDs, and/or through projection devices that project images on surfaces in the aircraft cabin. The information and objects may be displayed on see-through display devices that are mounted on cabin windows (e.g., as part of the window assembly) or held adjacent to cabin windows (e.g., via PEDs) to virtually augment what passengers see through their cabin windows.

Some operations that can be performed by an IFE system to inform passengers as to what AOEs are presently viewable through their windows and/or what AOEs will become viewable in the future are discussed below. In accordance with some embodiments of the present disclosure, an IFE system includes at least one network interface, at least one processor connected to communicate through at least one network interface, and at least one memory storing instructions executable by at least one processor to perform operations. The operations include obtaining an aircraft geographic location and heading. The operations also include selecting a set of AOEs from an AOEs database that satisfies a relevance rule to what is viewable by a passenger through a window of an aircraft. The operations also include communicating with a display device to display an indication of the AOEs in the selected set which are viewable by the passenger.

FIG. 1 illustrates a view of stars forming the Southern Cross constellation which is determined by the IFE system to be viewable in the nighttime sky of the Southern Hemisphere by passengers through windows along one side of an aircraft, in accordance with some embodiments of the present disclosure.

FIG. 2 illustrates information displayable by the IFE system through display devices to passengers who are located along the side of the aircraft in FIG. 1 to inform the passengers of the viewable AOEs, in accordance with some embodiments of the present disclosure. In the illustrated example, the displayed information can include a graphical representation of the locations of the stars forming the Southern Cross constellation and the Pointer constellation, and may provide a technical description of the stars, the constellation, distance of the AOE from earth, location of the AOE in the solar system or galaxy, and/or other related information of interest to passengers, and may provide photographs and other pictures and/or graphical representations related to the AOEs.

The IFE system can operate to determine what AOEs are presently viewable and what AOEs will become viewable to which passengers based on information obtained from a database indicating AOEs and their respective locations relative to Earth, and based on where the aircraft is located (e.g., longitude and latitude, altitude), the flight route of the aircraft, aircraft heading, aircraft pitch and/or roll, present and forecasted aircraft ground speed, the passenger's FOV through the closest window, etc. The operations can facilitate the representation of the celestial landscape to passengers during the flight, and serve to augment the passenger's in-flight experience by providing a captivating and immersive view of the AOEs through their windows and/or through images projected on cabin surfaces to enable observation as if the aircraft's ceiling was transparent.

The IFE system operations may include selecting the set of AOEs from the AOE database, includes to select the set of AOEs from the AOE database that satisfy the relevance rule for what AOEs are viewable at the geographic location of the aircraft.

In some embodiments, the IFE system operation to select the set of AOEs from the AOE database further includes obtaining a flight path of the aircraft and selecting the set of AOEs from the AOE database that satisfy the relevance rule for what AOEs will become viewable along the flight path of the aircraft.

In some of these embodiments, the IFE system obtains the ground speed of the aircraft. The operations then determine a time of arrival and departure for a future window of viewability of AOEs based on the flight path and the ground speed of the aircraft. The operations further include communicating with at least one display device to display an indication of the time of arrival and departure of the future window of viewability of the AOEs which will be viewable by the passenger during the future window of viewability.

In some embodiments, the operation to select the set of AOEs from the AOE database, further includes obtaining a flight path of the aircraft, estimating the passenger's field-of-view over time through a window based on the location of the passenger's seat in a direction across the aircraft and based on the aircraft geographic location, heading, and flight path, and select the set of AOEs from the AOE database that satisfy the relevance rule for what AOEs will become viewable along the flight path of the aircraft by the passenger with the estimated field-of-view. The operations of the IFE system may further include obtaining the ground speed of the aircraft. The operations of the IFE system can further include determining a time of arrival and departure for future windows of viewability of AOEs based on the flight path, the ground speed of the aircraft, and the passenger's field of view over time through the window. The operations of the IFE system can further include communicating with at least one display device to display an indication of the time of arrival and departure of the future window of viewability of the AOEs which will be viewable by the passenger during the future window of view ability through the window.

A map of the astronomical sky and other AOEs may be dynamically presented to passengers through various interfaces, such as an IFE display device (such as a seatback video display unit or SVDU), a paired PED (e.g., laptop computer, tablet computer, smartphone, etc.), and/or through a video projector which is configured to project images onto a cabin surface, such as the cabin ceiling. This celestial view may seamlessly synchronize with a ground map, enabling passengers to receive real-time AOE updates as a complementary extension to the progression of the ground map as the aircraft travels along the flight route.

FIG. 3 illustrates other information that is displayable through displays to passengers to inform the passengers of what AOEs are presently viewable through their respective windows and what AOEs will become viewable as the aircraft continues along its planned flight route, in accordance with some embodiments of the present disclosure. The IFE system may enable passengers to obtain information on the AOEs, such as textual and/or graphical information (e.g., pictures and/or animations) and/or scientific information, and other information of interest to passengers. Information on the AOEs may be provided responsive to a passenger indicating the selection of one of the AOEs in the selected set which is being displayed on a display device to the passenger. Passenger selection may be indicated by touch selection of an AOE displayed on an SVDU and/or PED paired to the IFE system, by entering a number corresponding to an AOE displayed in a list of AOEs, etc. The IFE system retrieves from the AOEs database textual and/or graphical information on characteristics of the selected one of the AOEs and communicates with a display device associated with the user to display the textual and/or graphical information.

In some embodiments, the IFE system operations display an image(s) of the AOEs in the selected set on a display unit in the aircraft. The operations may additionally or alternatively display an image(s) of the AOEs in the selected set on a PED of the passenger. The image may be computer-generated or may be an astronomical photo captured by a telescope or other camera. The image may also correspond to an animation, such as an animation that illustrates how one or more AOEs will move across the sky as the aircraft travels along its planned flight route while the Earth rotates.

In other words, in some embodiments, the operations include to, responsive to a passenger indicating selection of one of the AOEs in the selected set which are viewable by the passenger, retrieving from the AOEs database textual and/or graphical information regarding characteristics of the selected one of the AOEs. The operations communicate with the display device associated with the passenger to display the textual and/or graphical information.

The versatility of this IFE system, whether displayed on screens or projected onto the aircraft ceiling, can provide passengers with the illusion of a celestial “moon roof” or a boundless, unobstructed sky from within the aircraft.

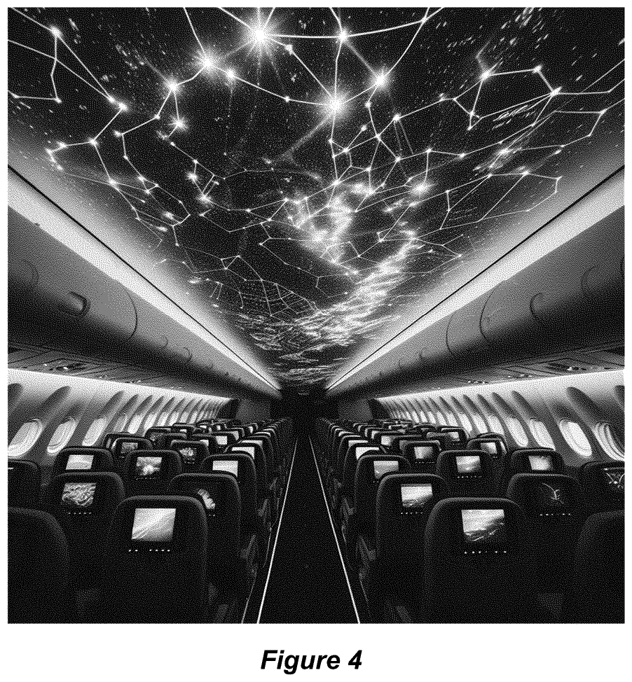

FIG. 4 illustrates an interior view of an aircraft cabin with a current or future view of AOEs in the sky projected through a projection device on the ceiling of the cabin in accordance with some embodiments of the present disclosure. The projected view of AOEs is shown as an imaginary dense group of constellations which is provided as a non-limiting way to illustrate how AOEs can be projected onto a cabin surface, such as the cabin ceiling, for viewing by passengers. A plurality of video projector devices (e.g., micro-video projectors) may be mounted at spaced apart locations along the aircraft cabin, e.g., in overhead storage bins, to project images on corresponding spaced apart regions of the cabin ceiling or other cabin surfaces, e.g., overhead storage bin surfaces, bulkheads, cabin side surfaces, etc.

Furthermore, various embodiments encompass additional features tailored towards delivering a comprehensive virtual space experience highlighting AOEs. The virtual space view may adapt based on factors such as the passenger's location within the aircraft (SVDU location or PED-based seat assignment), aircraft heading, aircraft pitch and/or roll, and the FOV of individual passengers or groups of passengers (e.g., along different cabin sides) through the respective cabin windows.

In some embodiments, the operation to select the set of AOEs from the AOE database further includes estimating the passenger's FOV through a window based on the location of the passenger's seat in a direction across the aircraft and based on the aircraft's geographic location and heading. The operation to select the set of AOEs from the AOE database also further includes selecting the set of AOEs from the AOE database that satisfies the relevance rule for what AOEs are viewable by the passenger with the estimated FOV.

A software application can provide a user interface that enables passengers to change the location of the aircraft, the time of day, and/or the day of year. The IFE system operations can respond to user input by computing corresponding changes to the representation of observable AOEs, their upcoming viewability, and the anticipated duration of visibility. The operations can identify transitory celestial events and related viewing opportunities for the particular passenger's FOV through the closest cabin window, such as when and for how long satellites, space stations, solar eclipses, lunar, eclipses, etc. will be viewable and where to look within the passenger's FOV to increase the likelihood of the passenger observing the AOE.

In some embodiments, the operations further include obtaining a flight path of the aircraft. The operations receive passenger input through a user interface of the display device displaying the flight path to move a virtual airplane along the flight path. The operations determine changes to the selected set of AOEs and indications of the AOEs which are viewable by the passenger.

A passenger-centric AOE determination algorithm can perform its computations based on a variety of parameters, as described above, which can include aircraft location (longitude and latitude), heading, pitch, roll, flight plan, ground speed, estimated flight timeline, time left to landing, and differences in viewable AOEs concerning destination airport versus origin airport, passenger travel itinerary destination(s) or current locations versus passenger-specific home locations, etc. The operations can also use passenger-indicated interests to refine the AOEs selected for informing the passengers to provide a more passenger-focused experience.

In some embodiments, the operations select or highlight to passengers which AOEs are unique for the passengers or for a particular passenger, such as AOEs different from what the passenger can see at home during this time of year. For example, the IFE system may identify astronomical objects that are different from what is viewable where the passenger lives or locations where the passenger primarily resides/travels from based on passenger-specific information such as a passenger's home address, current flight itinerary, previous flight itineraries, etc.

In some embodiments, the IFE system operation to select the set of AOEs from the AOE database further includes obtaining a passenger's geographic home location and geographic destination location. The operation selects a home-location set of AOEs from the AOE database that satisfies the relevance rule for what AOEs are viewable from the passenger's geographic home location within a defined timeframe. The operation selects a destination-location set of AOEs from the AOE database that satisfies the relevance rule for what AOEs are viewable from the passenger's geographic destination location within the defined timeframe. The operation generates a unique set of AOEs that are viewable from the passenger's geographic destination location which are not among the home-location set of AOEs.

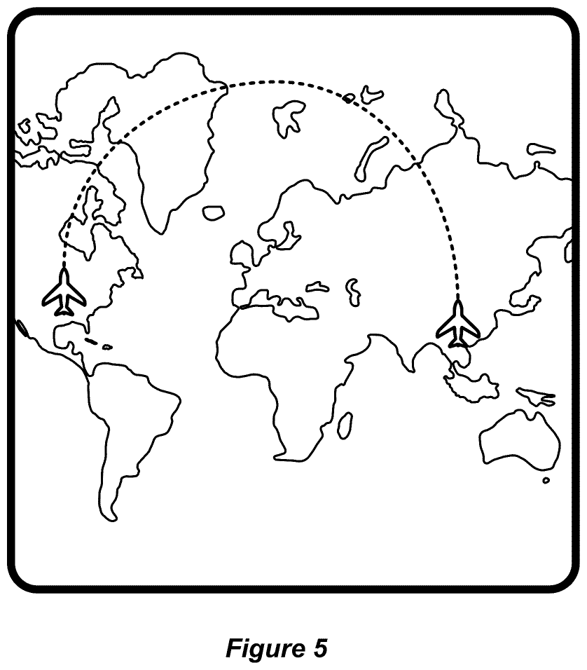

In some embodiments, AOEs are selected based on being unique to what the passenger will be able to see along the flight path, such as different from what the passenger can see at home during this time of year and other factors. FIG. 5 illustrates a flight route displayed to a passenger through a display device that allows a passenger to move an aircraft icon along the flight route to various locations causing the IFE system to display updated listings of AOEs that will be viewable when the aircraft arrives at those locations in accordance with some embodiments of the present disclosure.

Referring to FIG. 5, in some embodiments, the operation to select the set of AOEs from the AOE database further includes obtaining a flight path of the aircraft. The operation determines a point-of-interest location along the flight path and selects a home-location set of AOEs from the AOE database that satisfies the relevance rule for what AOEs are viewable from the passenger's geographic home location within a defined timeframe. The operation selects a destination-location set of AOEs from the AOE database that satisfies the relevance rule for what AOEs are viewable from the passenger's geographic destination location within the defined timeframe. The operation generates a unique set of AOEs that are viewable from the point-of-interest location which are not among the home-location set of AOEs or the destination-location set of AOEs.

The interactive nature of the IFE system extends to passenger collaboration and interaction regarding observable objects. For instance, in some embodiments, passengers may collectively vote on or discuss objects they wish to see, fostering engagement and a shared experience during the journey.

In some embodiments, an AOE of the set of AOEs is a solar eclipse or lunar eclipse. The IFE system operations further include determining an estimated time of arrival and time of departure along the aircraft flight path for viewing the solar eclipse or lunar eclipse.

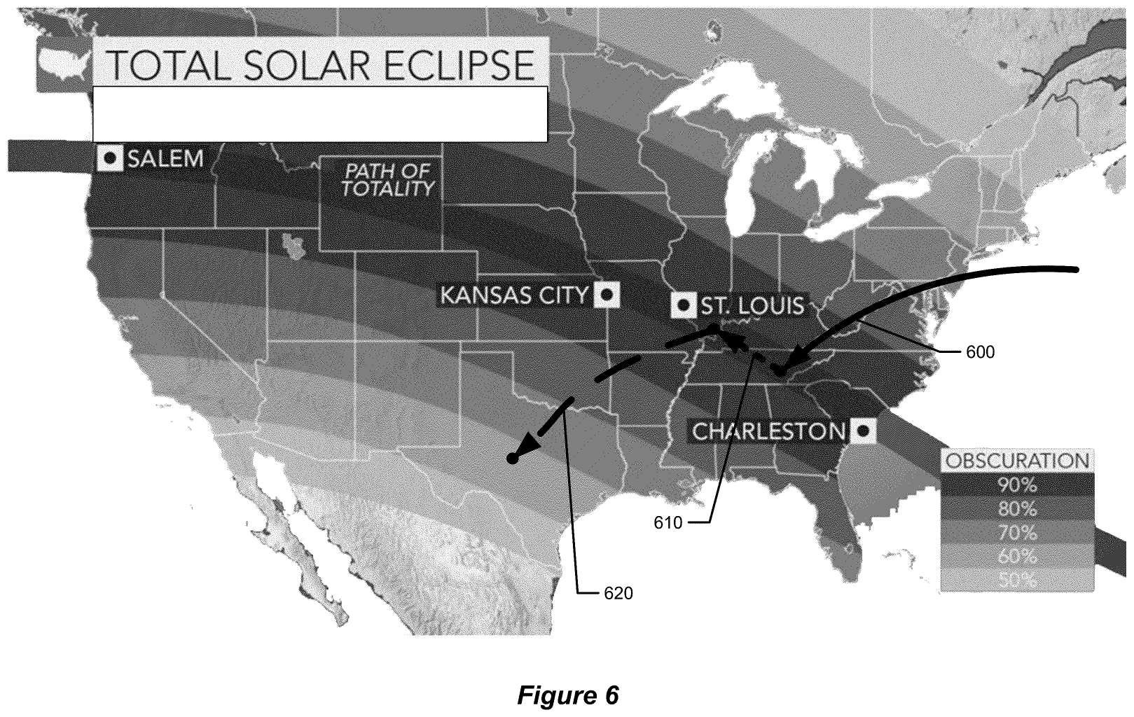

FIG. 6 illustrates a view of flight path 600 which traverses the track of a total solar eclipse, and can be displayed to allow a pilot to plan a modified flight route segment that will increase the duration of eclipse viewing opportunities for passengers, in accordance with some embodiments of the present disclosure. The view may also or alternatively be displayed to passengers through SVDUs and/or PEDs to inform them of the upcoming viewing opportunity.

In some embodiments, a pilot of the aircraft may be provided a user interface through the IFE system that can recommend a flight route segment 610 and/or through which the pilot may generate a flight route segment 610 in a region of the solar eclipse to extend the viewing opportunity for passengers. The IFE system operations can compute an estimate of the duration of the viewing opportunity for the solar eclipse if the aircraft maintains its flight path 600 and compute an estimate of the extended duration of the viewing opportunity if the aircraft diverts to take the flight route segment 610 in the region of the solar eclipse. The IFE system operations may recommend or enable the pilot to plan a continued route 620 to the destination with computation and display of an additional flight time added to the trip compared to the flight time that would have occurred if the aircraft had continued along the original route 600 without diversion along the flight route segment 610.

In some embodiments, the IFE system operations include modifying a segment of a flight path in a region of the solar eclipse to obtain a modified estimate of the duration of viewing of the solar eclipse.

As described through this example of a solar eclipse, some AOEs may be viewable for only a brief period. The IFE system can operate to dynamically update the passenger view based on the above aircraft flight parameters and based on present and forecasted cloud cover above the aircraft. The displayed information can inform passengers as to when AOEs will become visible or cease to be observable. For time-sensitive astronomical objects and events, the system may issue notifications (displayed alerts, electronic notifications via the display, audio output, vibration, etc.) to passengers through the SVDU and/or PEDs, increasing the passenger's chance of successfully observing brief AOE occurrences along the flight path.

In other words, in some embodiments, the operations further include obtaining orbital paths and timelines of Earth orbital AOEs from the AOEs database. The operations select a set of the Earth orbital AOEs that satisfy a relevance rule to what is viewable by a passenger through a window of the aircraft. The operations communicate with the display device to display an indication of the AOEs in the selected set which are viewable by the passenger. The indication of the AOEs in the selected set which are viewable by the passenger may be to what the passenger is able to view from their designated seat out of a window, what the passenger is able to view through the SVDU and/or PEDs, or what the passenger is able to view with the projection device.

The passenger may also be provided instructions on where to look out the airplane window, based on a passenger's FOV through the window, to see one of the AOEs in the selected set. In other words, in some embodiments, the operations further include determining a graphical indication of where the passenger can look out the window. The operations display the graphical indication of where the passenger can look out the window on a display device associated with the passenger.

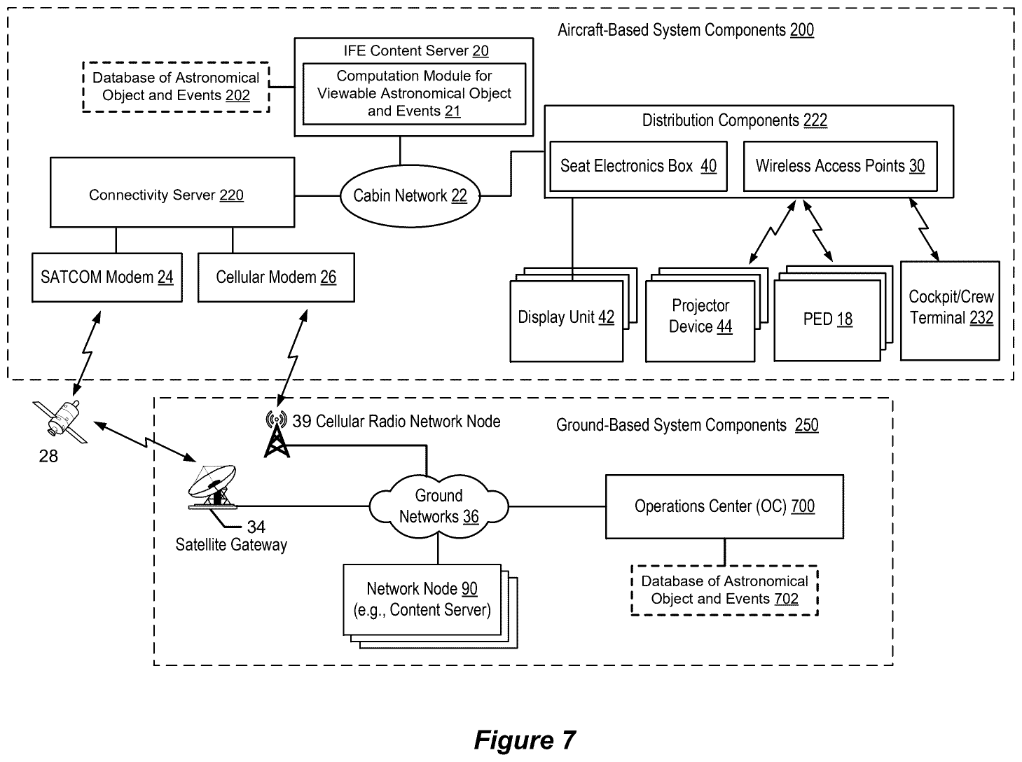

FIG. 7 illustrates an example simplified system block diagram of a system that includes aircraft-based and ground-based system components that can be operated in accordance with some embodiments.

Referring to FIG. 7, the aircraft-based system components 200 include wired-network display units 42 which communicate through respective seat electronics box 40 and/or wireless access points 30 (e.g., WiFi access points and/or cellular access points (e.g., a pico-cell radio base station)) of distribution components 222. The display unit 42 can include, without limitation, seat video display units that are mounted to individual seats, e.g., seatbacks or armrests. PEDs 18 are transportable onto the aircraft and can include, without limitation, cellular phones, tablet computers, and laptop computers. PEDs 18 can be paired to the display units 42 to communicate and/or can connect through the wireless access points 30 to communicate through networks 22, e.g., Ethernet, with an IFE content server 20 and/or a connectivity server 220 to communicate offboard with ground-based system components 250, such as network nodes 90 which can include content servers, etc. The connectivity server 220 can provide offboard connectivity via a SATCOM modem 24 which communicates through satellite(s) 28 and satellite gateway 34 and/or via a cellular modem 26 which communicates through cellular radio network nodes 39 and ground networks 36 to the network nodes 90 and/or operations center (OC) 700.

In accordance with various embodiments, computation module 21 determines which AOEs listed in a database of AOEs are viewable by passengers through one or more of the operational embodiments explained herein. The database of AOEs may reside onboard the aircraft, such as the database 202 which may be part of the IFE content server 20 or communicatively connected thereto through, e.g., the cabin network 22. The database of AOEs may alternatively or additionally reside offboard the aircraft, such as the database 702 which may be part of the OC 700, one of the content servers 90, or elsewhere that is communicatively connected to the computation module 21 via the connectivity server 200 and one or more wireless networks. The computation module 21 may be hosted by the IFE content server 20 and/or by another system component, and some of the functionality described herein for determining AOEs that are viewable or will become viewable by a passenger and/or for displaying AOE-related information can be performed by the PED 18. Projector devices 400 may be mounted at spaced apart locations along the aircraft cabin, e.g., in overhead storage bins, to project images on corresponding spaced apart regions of the cabin ceiling or other cabin surfaces, e.g., overhead storage bin surfaces, bulkheads, cabin side surfaces, etc.

Operation of the computation module 21 to selecting AOEs may be performed responsive to commands from passengers/crew via the display units 42, PEDs 18, cockpit/crew terminals 232, and/or responsive to commands triggered by operational modes or occurrence of other defined events identified by the IFE content server 20. For example, an onboard or offboard controller may trigger (initiate) execution of selecting and/or performing AOEs on one or more defined PEDs 18, display units 42, projector units 44, and/or crew terminals 232. The onboard or offboard controller may schedule how often the IFE content server 20 selects a set of AOEs from the database of AOEs 202.

### Further Definitions and Embodiments

In the above description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware without software or maybe a combination of hardware and software executed by a computer controller.

It is to be understood that the terminology used herein is for the purpose of describing particular embodiments only and is not intended to be limiting to the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The terminology used herein is for the purpose of describing particular aspects only and is not intended to be limiting to the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Reference numbers signify elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application and to enable others of ordinary skill in the art to understand the disclosure with various modifications as are suited to the particular use contemplated.

1. An IFE system comprising:
at least one network interface;
at least one processor connected to communicate through the at least one network interface; and
at least one memory storing instructions executable by the at least one processor to perform operations comprising to:
obtain an aircraft geographic location and heading;
select a set of astronomical objects and events (AOEs) from an AOEs database that satisfy a relevance rule to what is viewable by a passenger through a window of an aircraft;
communicate with a display device to display an indication of the AOEs in the selected set which are viewable by the passenger.

2. The IFE system of claim 1, wherein the operation to select the set of AOEs from the AOE database, comprises to:
select the set of AOEs from the AOE database that satisfy the relevance rule for what AOEs are viewable at the geographic location of the aircraft.

3. The IFE system of claim 2, wherein the operation to select the set of AOEs from the AOE database, further comprises to:
estimate the passenger's field-of-view through a window based on location of the passenger's seat in a direction across the aircraft and based on the aircraft geographic location and heading; and
select the set of AOEs from the AOE database that satisfy the relevance rule for what AOEs are viewable by the passenger with the estimated field-of-view.

4. The IFE system of claim 1, wherein the operation to select the set of AOEs from the AOE database, further comprises to:
obtain a flight path of the aircraft; and
select the set of AOEs from the AOE database that satisfy the relevance rule for what AOEs will become viewable along the flight path of the aircraft.

5. The IFE system of claim 4, wherein the operation further comprise to:
obtain a ground speed of the aircraft;
determine a time of arrival and departure for future-window of viewability of AOEs based on the flight path and the ground speed of the aircraft; and
communicate with the at least one display device to display an indication of the time of arrival and departure of the future-window of viewability of the AOEs which will be viewable by the passenger during the future-window of viewability.

6. The IFE system of claim 1,
wherein the operation to select the set of AOEs from the AOE database, further comprises to:
obtain a flight path of the aircraft,
estimate the passenger's field-of-view over-time through a window based on location of the passenger's seat in a direction across the aircraft and based on the aircraft geographic location, heading, and flight path, and
select the set of AOEs from the AOE database that satisfy the relevance rule for what AOEs will become viewable along the flight path of the aircraft by the passenger with the estimated field-of-view; and
the operations further comprise to:
obtain a ground speed of the aircraft;
determine a time of arrival and departure for future-window of viewability of AOEs based on the flight path, the ground speed of the aircraft, and the passenger's field-of-view over-time through the window; and
communicate with the at least one display device to display an indication of the time of arrival and departure of the future-window of viewability of the AOEs which will be viewable by the passenger during the future-window of viewability through the window.

7. The IFE system of claim 1, wherein the operation to select the set of AOEs from the AOE database, further comprises to:
obtain a passenger's geographic home location and geographic destination location;
select a home-location set of AOEs from the AOE database that satisfy the relevance rule for what AOEs are viewable from the passenger's geographic home location within a defined timeframe;
select a destination-location set of AOEs from the AOE database that satisfy the relevance rule for what AOEs are viewable from the passenger's geographic destination location within the defined timeframe;
generate a unique set of AOEs that are viewable from the passenger's geographic destination location which are not among the home-location set of AOEs.

8. The IFE system of claim 1, wherein the operation to select the set of AOEs from the AOE database, further comprises to:
obtain a flight path of the aircraft;
determine a point-of-interest location along the flight path;
select a home-location set of AOEs from the AOE database that satisfy the relevance rule for what AOEs are viewable from the passenger's geographic home location within a defined timeframe;
select a destination-location set of AOEs from the AOE database that satisfy the relevance rule for what AOEs are viewable from the passenger's geographic destination location within the defined timeframe; and
generate a unique set of AOEs that are viewable from the point-of-interest location which are not among the home-location set of AOEs or the destination-location set of AOEs.

9. The IFE system of claim 1, the operations further comprises to:
obtain a flight path of the aircraft;
receive a passenger input through a user interface of the display device displaying the flight path to move a virtual airplane along the flight path;
determine changes to the selected set of AOEs and indication of the AOEs in the which are viewable by the passenger.

10. The IFE system of claim 1, wherein an AOE of the set of AOEs is a solar eclipse or lunar eclipse; and
the operations further comprises to:
determine an estimated time of arrival and time of departure along a flight path for viewing the solar eclipse or lunar eclipse.

11. The IFE system of claim 10, the operations further comprise to:
modify a segment of a flight path in a region of the solar eclipse or lunar eclipse to obtain a modified estimate of duration of viewing of the solar eclipse or lunar eclipse.

12. The IFE system of claim 10, the operations further comprise to:
responsive to a passenger indicating selection of one of the AOEs in the selected set which are viewable by the passenger, retrieve from the AOEs database textual and/or graphical information on characteristics of the selected one of the AOEs; and
communicate with the display device associated with the passenger to display the textual and/or graphical information.

13. The IFE system of claim 1, the operations further comprise to:
obtain orbital paths and timelines of Earth orbital AOEs from the AOEs database;
select a set of the Earth orbital AOEs that satisfy a relevance rule to what is viewable by a passenger through a window of the aircraft; and
communicate with the display device to display an indication of the AOEs in the selected set which are viewable by the passenger.

14. The IFE system of claim 1, the operations further comprise to:
determine a graphical indication of where the passenger can look out the window; and
display the graphical indication of where the passenger can look out the window on a display device associated with the passenger.

15. The IFE system of claim 1, the operations further comprise to:
display an image of the AOEs in the selected set on a ceiling of the aircraft with a projection device.

16. The IFE system of claim 1, the operations further comprise to:
display an image of the AOEs in the selected set on a display unit in the aircraft.

17. The IFE system of claim 1, the operations further comprise to:
display an image of the AOEs in the selected set on a passenger electronic device, PED, of the passenger.
